(19) United States
(12) Patent Application Publication
(10) Pub. No.: US 2014/0359070 A1
(43) Pub. Date: Dec. 4, 2014

(54) Systems and Methods for Critical Path Synchronization of Content Rendering

(71) Applicants: Sridhar Sundaram, Bangalore (IN); Ram Ramani, Bangalore (IN); Richard Rabbat, Palo Alto, CA (US)

(72) Inventors: Sridhar Sundaram, Bangalore (IN); Ram Ramani, Bangalore (IN); Richard Rabbat, Palo Alto, CA (US)

(73) Assignee: GOOGLE INC., Mountain View, CA (US)

(21) Appl. No.: 13/076,349

(22) Filed: Mar. 30, 2011

(51) Int. Cl. G06F 15/16

(52) U.S. Cl. 709/219

(57) ABSTRACT

Methods and apparatus related to critical-path ordering of content, such as web pages, are disclosed. A request to transmit content is received at a critical-path server. The content includes one or more components. The one or more components of the content are received. A critical-path ordering for the one or more components is determined. The critical-path ordering can be based on device information, critical-path data, and/or one or more content rules. The critical-path data can be related to one or more preferences, such as but not limited to time-budget entries and content-priority preferences. One or more critical components of the one or more components can be determined based on the critical-path ordering. The one or more components, beginning with the one or more critical components, are transmitted in accordance with the critical-path ordering.

### BACKGROUND

Unless otherwise indicated herein, the materials described in this section are not prior art to the claims in this application and are not admitted to be prior art by inclusion in this section.

Various technologies can be utilized to electronically exchange information between users. For example, computers, telephones, and personal digital assistants (PDAs) can be used to exchange content over communication networks including the Internet. The content exchanged between such devices can include web pages that, in turn, can include text, video data, audio data and/or other types of data. Typically, “best effort” techniques are used in communicating the content over the Internet; that is, no guarantees are provided that data is delivered or that a quality of service is assured while communicating the content. In best effort delivery, an entity receiving content typically adapts to the network's timing for delivering content by waiting for the content.

### SUMMARY

In one aspect of the disclosure of the application, a first request to transmit content is received at a critical-path server. The content includes one or more components. The critical-path server sends a request for the one or more components of the content. The critical-path server receives the one or more components of the content. The critical-path server is used to determine a critical-path ordering for the one or more components. The critical-path ordering is based on device information, critical-path data, and one or more content rules. The critical-path data includes time-budget information. One or more critical components of the one or more components are determined based on the critical-path ordering. The one or more components are transmitted, beginning with the one or more critical components, from the critical path server in accordance with the critical-path ordering.

In another aspect of the disclosure of the application, a first request to transmit content is received at a critical-path server. The content includes one or more components. A determination is made whether or not additional content is required to generate a first critical-path ordering. Responsive to determining that additional content is not required to generate the first critical-path ordering, the first critical-path ordering is generated using the critical-path server. The first critical-path ordering is derived at least from device information and critical-path data. The critical-path data includes time-budget information. One or more critical components of the one or more components are determined based on the first critical-path ordering. The one or more components are transmitted, beginning with the one or more critical components, from the critical-path server in accordance with the first critical-path ordering.

In another aspect of the disclosure of the application, a system is provided. The system includes one or more processors. The one or more processors are at least configured to: (a) receive a first request to transmit content, the content comprising one or more components, (b) sending a request for the one or more components, (c) receive the one or more components of the content, (d) determine a critical-path ordering for the one or more components of the content, where the critical-path ordering is derived from device information, critical-path data, and one or more content rules, and where the critical-path data includes time-budget information, (e) determine one or more critical components of the one or more components based on the critical-path ordering, and (f) transmit the one or more components, beginning with the one or more critical components, in accordance with the critical-path ordering.

In yet another aspect of the disclosure of the application, an article of manufacture including a tangible non-transitory computer-readable storage medium having computer-readable instructions encoded thereon is provided. The computer-readable instructions include: (a) instructions for receiving a first request to transmit content, the content comprising one or more components, (b) instructions for sending a request for the one or more components, (c) instructions for receiving the one or more components of the content, (d) instructions for determining a critical-path ordering for the one or more components of the content, where the critical-path ordering is derived from device information, critical-path data, and one or more content rules, and where the critical-path data includes time-budget information, (e) instructions for determining one or more critical components of the one or more components based on the critical-path ordering, and (f) instructions for transmitting the one or more components, beginning with the one or more critical components, in accordance with the critical-path ordering.

In still another aspect of the disclosure of the application, an apparatus is provided. The apparatus includes: (a) means for receiving a first request to transmit content, where the content comprising one or more components, (b) means for sending a request for the one or more components of the content, (c) means for receiving the one or more components of the content, (d) means for determining a critical-path ordering for the one or more components of the content, where the critical-path ordering is derived from device information, critical-path data, and one or more content rules, and where the critical-path data includes time-budget information, (e) means for determining one or more critical components of the one or more components based on the critical-path ordering, and (f) means for transmitting the one or more components, beginning with the one or more critical components, in accordance with the critical-path ordering.

### BRIEF DESCRIPTION OF THE FIGURES

FIG. 1 depicts a network in accordance with an example embodiment.

FIG. 2A is a block diagram of a computing device in accordance with an example embodiment.

FIG. 2B depicts a network with computing clusters in accordance with an example embodiment.

FIG. 3 is a ladder diagram in accordance with an example embodiment.

FIG. 4A is another ladder diagram in accordance with an example embodiment.

FIG. 4B is a ladder diagram illustrating an overall critical-path ordering in accordance with an example embodiment.

FIG. 5 depicts a critical-path ordering for content in accordance with an example embodiment.

FIG. 6A illustrates example content in accordance with an example embodiment.

FIG. 6B shows a scenario for displaying content in accordance with an example embodiment.

FIG. 6C shows another scenario for displaying content in accordance with an example embodiment.

FIG. 7 is a flow chart of another example method in accordance with an example embodiment.

### DETAILED DESCRIPTION

The following detailed description describes various features and functions of the disclosed systems, devices, and methods with reference to the accompanying figures. In the figures, similar symbols typically identify similar components, unless context dictates otherwise. The illustrative embodiments described in the detailed description, figures, and claims are not meant to be limiting. Other embodiments can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Overview

Techniques are described herein for communicating content using a critical-path ordering for the content. Content can be analyzed using content rules to determine one or more components of the content. For example, content such as a web page can have text, images, video, audio, and/or other types of components. Using the critical-path ordering to deliver content takes advantage of the observation that user perceptions are coarse-grained and highly parallelized and that machine capabilities are fine-grained and sequential.

Most content, such as web pages, has one or more critical components that are fundamental to the reviewing the content. That is, experience of the content is incomplete without the critical components being delivered. Other non-critical components add value by enhancing the user experience. As an analogy, components of an automobile that can be considered as critical could be wheels, a motor to drive the wheels, and controls, such as a steering wheel and brakes. Other components, such as upholstery, body contours, hub caps, and other accoutrements, may be important but could be considered as non-critical.

The critical-path ordering of content components can permit critical components to be delivered while the non-critical parts are in process of delivery to a requesting device, such as a client device. To that end, critical-path data can indicate that some components can have higher or lower value than other components, and thus should have correspondingly higher or lower priority in the critical-path ordering.

User experience of content display can be improved by splitting the content into components and delivering higher-priority components before lower-priority components. Even as the higher-priority components are being displayed, the lower-priority components can be transmitted over the network and replaced in the displayed content. In some cases, the lower-priority content can seamlessly replace the higher-priority content. The collection of critical-path ordering techniques described herein can provide delivery of content within the desired time budget most of the time, even if the content is delivered using one or more best-effort networks (e.g., the Internet).

A critical-path server can determine the critical-path ordering for requested content by analyzing the requested content according to device information, the critical-path data, and/or the content rules. The critical-path ordering can be used to prioritize transmission of the components of the requested content from the critical-path server to the requesting client device. The most important, i.e., highest-priority in the critical-path ordering, components may be transmitted first, while less important or lower-priority components may be transmitted after the most-important components.

As another example, the critical-path data can include information about a time budget. The time budget can be specified as one or more amounts of time related to delivering content. For example, the time-budget information can include one or more time-budget entries. Each time-budget entry can provide an amount of time for one or more phases for communicating content from one or more servers, such as the critical-path server and/or a content server, to a requesting device and/or displaying content using the requesting device. For example, time-budget entries can specify amounts of time for a requesting content phase, an initial server response phase, a content downloading phase, and a display or rendering phase. Then, the critical-path server and a client device can use the time-budget entries to determine an amount of time for performing each phase of content delivery. In this context, the sum or other combination of the times specified in the time-budget entries can constitute a time budget for displaying content.

As yet another example, the time budget can be specified as one or more times by which content is to be delivered or displayed. For example, the time budget can specify that content is to be delivered and displayed by a fixed time, such as 2 PM. Specifying time budgets in terms of a time for delivery or display can permit prioritization among many types of content; e.g., content to be delivered by 2 PM can have a higher priority than content delivered by 2:15 PM.

The times specified in the time-budget entries can be specified directly or implicitly by the critical-path server and/or the requesting device. The time-budget entries may be based on request intervals for requesting information and/or by ratings of delivered content. For example, suppose a user of a requesting device requests content C at time T1 and then re-requests C at time T1+2.2 seconds. The request interval, or time between requests of content C, can be determined by subtracting the times for requesting C or T1+2.2 seconds−T1=2.2 seconds. As another example, suppose content C1 was delivered with time(s) specified by time-budget entry/entries and then C1 was rated by a user as being “incomplete.” In response to the incomplete rating, times in one or more time-budget entries can be increased to increase the likelihood that C1 will be completely displayed in the future. Continuing the rating example, suppose content C2 was delivered and rated by a user as being “complete.” In response to the complete rating, times in one or more time-budget entries can be maintained, or perhaps decreased, to increase the likelihood that C2 will be displayed in the same or less time in the future. By use of critical-path data including time-budget entries, the client device can specify and thereby control the amount of time required to display content requested from the critical-path server.

Giving an entity, such as user or other computing device, implicit or explicit control over content-delivery timing can enhance the user experience. By using time budgets, the network supplying content to the entity adapts to the time budget to deliver content. In contrast, in best effort delivery, the entity often adapts by waiting to the network's timing for delivering content.

As another example, the critical-path ordering can take account of processor speeds of the client device, such as the speeds of central processing units (CPUs), graphics processing units (GPUs), and/or other processors driving content display on client device. For example, a first client device with one CPU operating with a clock speed of n gigahertz (GHz) and without a GPU is likely to take considerably longer to display content than a second client device with a quad-core CPU, each core operating at at least 2n GHz, and with a GPU.

Correspondingly, the critical-path server can determine that more content can be displayed on the second client device in a fixed time budget than on the first client device, and adjust the critical-path ordering accordingly. As one example, a priority of image content can be reduced.

As another example, for some component types, compressed or sub-sampled versions can be transmitted, perhaps to be replaced by later, uncompressed or fully-sampled versions of these components. For example, suppose the requested content included a 1024×1024 pixel image Image that had a high priority in the critical-path ordering and that the Image was ten times larger than any other component of the content. As content delivery time would be dominated by the Image, the critical-path server could determine that the Image can be replaced with a first, smaller compressed and/or sub-sampled image corresponding to the Image as a high-priority component. One or more higher-quality components corresponding to the Image could be later sent as lower-priority components to replace the earlier-transmitted components. Thus, the critical path server can provide a progressively higher quality display of the Image.

In some cases, the Image could be transmitted using interlacing or progressive encoding, such as using the interlacing techniques available for images encoded using Graphics Interchange Format (GIF), Portable Network Graphics (PNG), Joint Photographic Experts Group (JPEG), Progressive Graphics File (PGF), and/or other file formats supporting interlacing or progressive encoding. In these cases, the Image can be displayed using corresponding interlacing or progressive display techniques.

As content is delivered to the client device, the critical-path ordering can account for other properties of the client device. For example, devices capable of displaying content can have a predetermined display area. If the predetermined display area is smaller than a display size of content, a critical-path ordering can prioritize visible components of content over components that are not visible in the predetermined display area.

For example, suppose rendered content were to have a display size of 1000×1000 pixels, but a requesting client device has a display with a size of 400×400 pixels. Then, the components of the rendered content visible in the 400×400 screen can have a higher priority in a critical-path ordering than the not-visible components. In this example, the critical-path server can delay sending of not-visible components, and correspondingly speed the display of actually visible content. Various other properties of the client device can be accounted for as well.

The critical-path server can use connection information, or information about one or more networks connecting the client device and the critical-path server, to determine the critical-path ordering. The connection information can include but is not limited to bandwidth information, round-trip delay information, upload speeds, download speeds, and/or maximum number of connections. As one example, download speeds and/or bandwidth information can be used to estimate a maximum amount of data that can be transmitted to the client device in a predetermined amount of time. As another example, suppose a client device supports multiple simultaneous connections. Then, in some cases, a separate critical path ordering per connection can be determined and the multiple critical path orderings can be used to transmit content simultaneously. Other connection information and uses of connection information for determining critical-path orderings are possible as well.

Critical-path data and/or content rules can include data about preferences for content display and/or transmission. For example, an entity can set content-priority preferences in critical-path data to prioritize time-sensitive information over images, while another entity can use content-priority preferences to prioritize image delivery over textual data. Continuing the example of web page content, a web page could include text with time-sensitive information (e.g., stock quotes, sports scores, news feeds), text without time-sensitive information (e.g., articles, book excerpts, etc.), images, and audio information. In some embodiments, the content-priority preferences are determined by analyzing the content, perhaps by scanning for tags, meta-data, or other information within the content to determine content-priority preferences. In other embodiments, the critical path server can use content rules to determine content-priority preferences.

In some scenarios, multiple critical-path orderings can be used. For example, a content request can request content related to “World News.” Based on content-priority preference(s), location coordinates, a location associated with an address for the content request (e.g., an Internet Protocol (IP) address), and perhaps other information, a priority of news delivery can be determined. For example, suppose an IP address associated with the content request is associated with Bangalore, India. Then, the priority of “Indian News” can be increased within the World News request. An overall critical-path ordering can then be determined using the priorities of content to be delivered in response to the World News request. For example, for a request associated with Bangalore, the overall critical-path ordering can reflect that one or more content items regarding news about India is to be delivered before any content items over other locations in the world. Then, for each content item specified in the overall critical-path ordering, a content-item-specific critical-path ordering in turn can be determined; for example, to prioritize text over images (or vice versa) within the content item.

In some cases, one or more content-item-specific critical-path orderings can be determined before a content request is received. In these cases, a given content request, such as the World News request, may be satisfied with an overall critical-path ordering for a number of content items, such as one or more news articles, where at least one content item has a corresponding critical-path ordering generated before reception of the given content request. For example, suppose that prior to the World News request, a critical-path ordering had been generated for a news article related to newsworthy events in Mumbai that would be delivered as part of the World News request. Then, the already-generated critical-path ordering(s) for those content item(s) can be used, in combination with the overall critical-path ordering, to satisfy a content request. In other cases, the overall critical-path ordering and critical path ordering(s) for content item(s) can be generated after receiving the content request.

Many other examples of content delivery using multiple critical-path orderings are possible as well, including but not limited to, additional levels of hierarchically-organized critical-path orderings, non-hierarchical critical-path orderings, critical-path orderings based on additional or different criteria than location, and other examples as well.

Components can be adapted to fit the device information, the critical-path data, the connection information, and/or the content rules. In particular, the time budget can cause the critical-path server to adapt one or more components of delivered content. The component adaptation is driven by the time budget available and a best estimate of what can be done within such budget. In some cases, functionality can be reduced in light of a time budget. For example, content providing e-mail access can revert to permitting only read and write access to e-mail while disabling search functionality due to time budgets.

In some embodiments, time budgets and critical-path orderings can be utilized separately. For example, let there be a time budget of T seconds for delivering content, which can be specified by an associated client device. The time budget for content can be satisfied by a server using any technique available to the server for delivering content to the associated client device, as long as the requested content is delivered within T seconds. Also, in some embodiments, critical-path orderings can be used without time budgets. For example, a critical-path server can determine a critical-path ordering for content without consideration of an amount of time required for delivering the content.

In other embodiments, time budgets and critical-path orderings can be utilized together. If a time budget of T seconds has been specified, perhaps via one or more time-budget entries, the critical-path server can utilize the time budget as an input for generating the critical-path ordering. For example, for relatively small values of T, the critical-path ordering can involve utilizing sub-sampled, compressed, or otherwise smaller, yet at least partially equivalent, versions of content to increase the number of components that can be delivered within the time budget of T seconds. As another example, the content server can determine that the components in the critical-path ordering are to be delivered utilizing more bandwidth (e.g., the content is delivered over faster and/or larger numbers of connections) when T is relatively small than when T is relatively large, thus permitting the same amount of content to be delivered with a relatively smaller time budget.

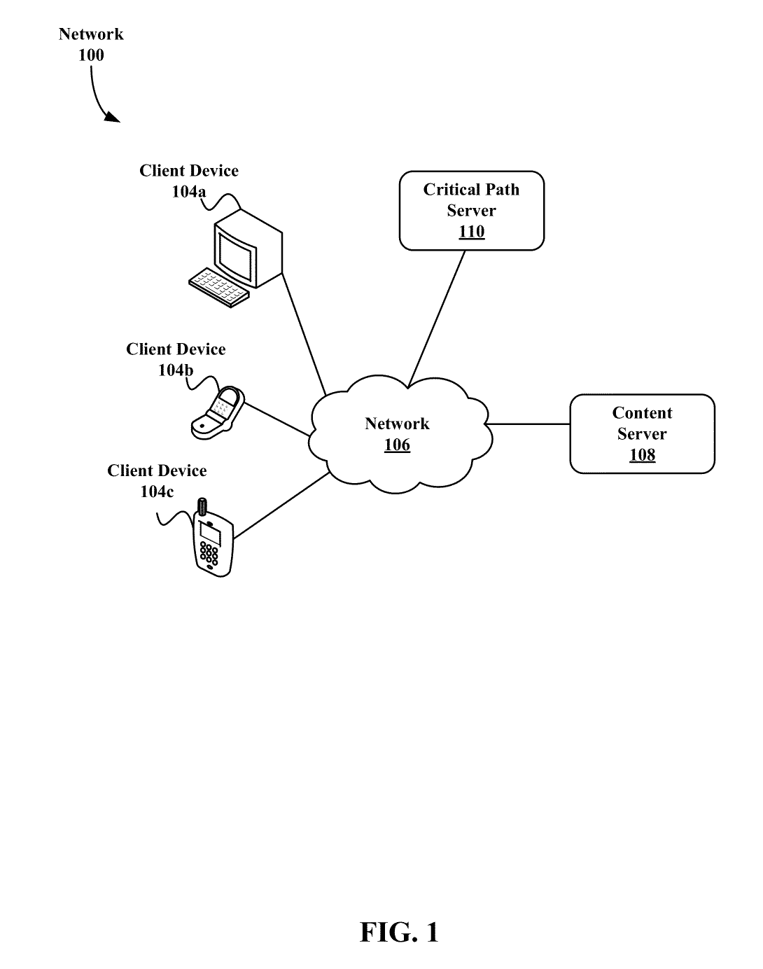

Turning to the figures, FIG. 1 depicts a network 100 in accordance with an example embodiment. In FIG. 1, content server 108 and critical-path server 110 are configured to communicate, via a network 106, with client devices 104a, 104b, and 104c. As shown in FIG. 1, client devices can include a personal computer 104a, a telephone 104b, and a smart-phone 104c. More generally, the client devices 104a, 104b, and 104c (or any additional client devices) can be any sort of computing device, such as an ordinary laptop computer, desktop computer, network terminal, wireless communication device (e.g., a cell phone or smart phone), and so on.

The network 106 can correspond to a local area network, a wide area network, a corporate intranet, the public Internet, combinations thereof, or any other type of network(s) configured to provide communication between networked computing devices. Content server 108 can provide content to client device 104a-104c and/or critical-path server 110. The content can include, but is not limited to, web pages, hypertext, scripts, binary data such as compiled software, images, audio, and/or video. The content can include compressed and/or uncompressed content. The content can be encrypted and/or unencrypted. Other types of content are possible as well.

Critical-path server 110 can be configured to generate and utilize critical-path orderings to deliver requested content. Alternatively, content server 108 and critical-path server 110 can be implemented on one computing device, be co-located, and/or be accessible via a network separate from the network 106. Although FIG. 1 only shows three client devices, content server 108 and/or critical-path server 110 can serve hundreds, thousands, or even more client devices.

Computing Device and Computing Network Architectures

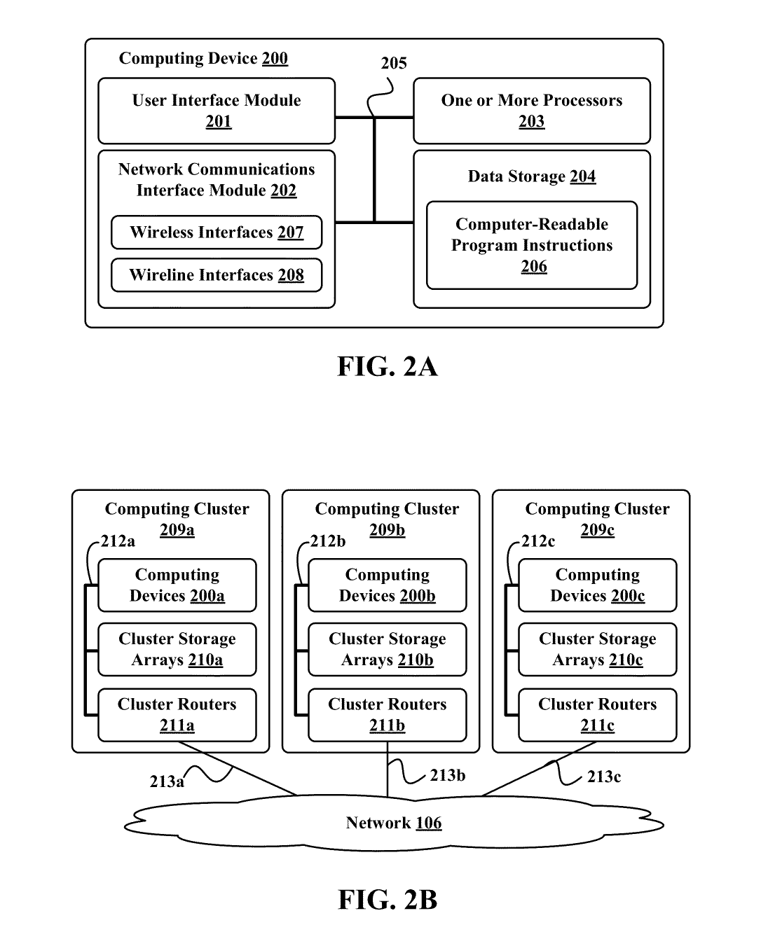

FIG. 2A is a block diagram of a computing device 200 in accordance with an example embodiment. Computing device 200 can be configured to perform one or more functions of client devices 104a, 104b, and 104c, content server 108, and/or critical-path server 110. The computing device 200 can include a user interface module 201, a network-communication interface module 202, one or more processors 203, and data storage 204, all of which can be linked together via a system bus, network, or other connection mechanism 205.

The user interface module 201 can be operable to send data to and/or receive data from external user input/output devices. For example, the user interface module 201 can be configured to send/receive data to/from user input devices such as a keyboard, a keypad, a touch screen, a computer mouse, a track ball, a joystick, and/or other similar devices, now known or later developed. The user interface module 201 can also be configured to provide output to user display devices, such as one or more cathode ray tubes (CRT), liquid crystal displays (LCD), light emitting diodes (LEDs), displays using digital light processing (DLP) technology, printers, light bulbs, and/or other similar devices, now known or later developed. The user interface module 201 can also be configured to generate audible output(s), such as a speaker, speaker jack, audio output port, audio output device, earphones, and/or other similar devices, now known or later developed.

The network-communications interface module 202 can include one or more wireless interfaces 207 and/or wireline interfaces 208 that are configurable to communicate via a network, such as the network 106 shown in FIG. 1. The wireless interfaces 207 can include one or more wireless transceivers, such as a Bluetooth transceiver, a Wi-Fi transceiver perhaps operating in accordance with an IEEE 802.11 standard (e.g., 802.11a, 802.11b, 802.11g), a WiMAX transceiver perhaps operating in accordance with an IEEE 802.16 standard, and/or other types of wireless transceivers configurable to communicate via a wireless network. The wireline interfaces 208 can include one or more wireline transceivers, such as an Ethernet transceiver, a Universal Serial Bus (USB) transceiver, or similar transceiver configurable to communicate via a wire, a twisted pair of wires, a coaxial cable, an optical link, a fiber-optic link, or other physical connection to a wireline network.

In some embodiments, the network communications interface module 202 can be configured to provide reliable, secured, compressed, and/or authenticated communications. For each communication described herein, information for ensuring reliable communications (e.g., guaranteed message delivery) can be provided, perhaps as part of a message header and/or footer (e.g., packet/message sequencing information, encapsulation header(s) and/or footer(s), size/time information, and transmission verification information such as cyclic redundancy check (CRC) and/or parity check values). Communications can be compressed and decompressed using one or more compression and/or decompression algorithms and/or protocols such as, but not limited to, one or more lossless data compression algorithms and/or one or more lossy data compression algorithms. Communications can be made secure (e.g., be encoded or encrypted) and/or decrypted/decoded using one or more cryptographic protocols and/or algorithms, such as, but not limited to, DES, AES, RSA, Diffie-Hellman, and/or DSA. Other cryptographic protocols and/or algorithms can be used as well or in addition to those listed herein to secure (and then decrypt/decode) communications.

The one or more processors 203 can include one or more general purpose processors and/or one or more special purpose processors (e.g., digital signal processors, application specific integrated circuits, etc.). The one or more processors 203 can be configured to execute computer-readable program instructions 206 that are contained in the data storage 204 and/or other instructions as described herein.

The data storage 204 can include one or more computer-readable storage media that can be read or accessed by at least one of the processors 203. The one or more computer-readable storage media can include volatile and/or non-volatile storage components, such as optical, magnetic, organic or other memory or disc storage, which can be integrated in whole or in part with at least one of the one or more processors 203. In some embodiments, the data storage 204 can be implemented using a single physical device (e.g., one optical, magnetic, organic or other memory or disc storage unit), while in other embodiments, the data storage 204 can be implemented using two or more physical devices.

Computer-readable storage media associated with data storage 204 and/or other computer-readable media described herein can also include non-transitory computer-readable media such as computer-readable media that stores data for short periods of time like register memory, processor cache, and random access memory (RAM). Computer-readable storage media associated with data storage 204 and/or other computer-readable media described herein can also include non-transitory computer readable media that stores program code and/or data for longer periods of time, such as secondary or persistent long term storage, like read only memory (ROM), optical or magnetic disks, compact-disc read only memory (CD-ROM), for example. Computer-readable storage media associated with data storage 204 and/or other computer-readable media described herein can also be any other volatile or non-volatile storage systems. Computer-readable storage media associated with data storage 204 and/or other computer-readable media described herein can be considered computer readable storage media for example, or a tangible storage device.

The data storage 204 can include computer-readable program instructions 206 and perhaps additional data. In some embodiments, the data storage 204 can additionally include storage required to perform at least part of the herein-described techniques, methods (e.g., method 700), and/or at least part of the functionality of the herein-described devices and networks.

FIG. 2B depicts a network 106 with computing clusters 209a, 209b, and 209c in accordance with an example embodiment. In FIG. 2B, functions of content server 108 and/or critical-path server 110 can be distributed among three computing clusters 209a, 209b, and 208c. The computing cluster 209a can include one or more computing devices 200a, cluster storage arrays 210a, and cluster routers 211a connected by local cluster network 212a. Similarly, computing cluster 209b can include one or more computing devices 200b, cluster storage arrays 210b, and cluster routers 211b connected by local cluster network 212b. Likewise, computing cluster 209c can include one or more computing devices 200c, cluster storage arrays 210c, and cluster routers 211c connected by a local cluster network 212c.

In some embodiments, each of computing clusters 209a, 209b, and 209c can have an equal number of computing devices, an equal number of cluster storage arrays, and an equal number of cluster routers. In other embodiments, however, some or all of computing clusters 209a, 209b, and 209c can have different numbers of computing devices, different numbers of cluster storage arrays, and/or different numbers of cluster routers. The number of computing devices, cluster storage arrays, and cluster routers in each computing cluster can depend on the computing task or tasks assigned to each computing cluster.

In computing cluster 209a, for example, computing devices 200a can be configured to perform various computing tasks of content server 108. In one embodiment, the various functionalities of content server 108 can be distributed among one or more of the computing devices 200a. For example, some of these computing devices can be configured to provide part or all of a first set of content while the remaining computing devices can provide part or all of a second set of content. Still other computing devices of the computing cluster 209a can be configured to communicate with critical-path server 110. Computing devices 200b and 200c in computing clusters 209b and 209c can be configured the same or similarly to the computing devices 200a in computing cluster 209a.

On the other hand, in some embodiments, computing devices 200a, 200b, and 200c each can be configured to perform different functions. For example, computing devices 200a and 200b can be configured to perform one or more functions of content server 108, and the computing devices 200c can be configured to perform one or more functions of critical-path server 110.

Cluster storage arrays 210a, 210b, and 210c of computing clusters 209a, 209b, and 209c can be data storage arrays that include disk array controllers configured to manage read and write access to groups of hard disk drives. The disk array controllers, alone or in conjunction with their respective computing devices, can also be configured to manage backup or redundant copies of the data stored in the cluster storage arrays to protect against disk drive or other cluster storage array failures and/or network failures that prevent one or more computing devices from accessing one or more cluster storage arrays.

Similar to the manner in which the functions of content server 108 and/or critical-path server 110 can be distributed across computing devices 200a, 200b, and 200c of respective computing clusters 209a, 209b, and 209c, various active portions and/or backup/redundant portions of these components can be distributed across cluster storage arrays 210a, 210b, and 210c. For example, some cluster storage arrays can be configured to store data for content server 108, while other cluster storage arrays can store data for critical-path server 110. Additionally, some cluster storage arrays can be configured to store backup versions of data stored in other cluster storage arrays.

The cluster routers 211a, 211b, and 211c in the computing clusters 209a, 209b, and 209c can include networking equipment configured to provide internal and external communications for the computing clusters. For example, the cluster routers 211a in the computing cluster 209a can include one or more internet switching and/or routing devices configured to provide (i) local area network communications between the computing devices 200a and the cluster storage arrays 201a via the local cluster network 212a, and/or (ii) wide area network communications between the computing cluster 209a and the computing clusters 209b and 209c via the wide area network connection 213a to the network 106. The cluster routers 211b and 211c can include network equipment similar to the cluster routers 211a, and the cluster routers 211b and 211c can perform similar networking functions for the computing clusters 209b and 209b that the cluster routers 211a perform for the computing cluster 209a.

In some embodiments, computing tasks and stored data associated with content server 108 and/or critical-path server 110 can be distributed across the computing devices 200a, 200b, and 200c using a variety of techniques. These techniques for distributing tasks and stored data can be based at least in part on the processing requirements for functions of content server 108 and/or critical-path server 110, the processing capabilities of the computing devices 200a, 200b, and 200c, the latency of the local cluster networks 212a, 212b, and 212c, the wide area network connections 213a, 213b, and 213c, and/or other factors that can contribute to the cost, speed, fault-tolerance, resiliency, efficiency, and/or other design goals of the overall system architecture.

Additionally, the configuration of the cluster routers 211a, 211b, and 211c can be based at least in part on the data communication requirements of the computing devices and cluster storage arrays, the data communications capabilities of the network equipment in the cluster routers 211a, 211b, and 211c, the latency and throughput of the local cluster networks 212a, 212b, 212c, the latency, throughput, and cost of the wide area network connections 213a, 213b, and 213c, and/or other factors that can contribute to the cost, speed, fault-tolerance, resiliency, efficiency and/or other design goals of the system architecture.

Time Budgets for Content Delivery

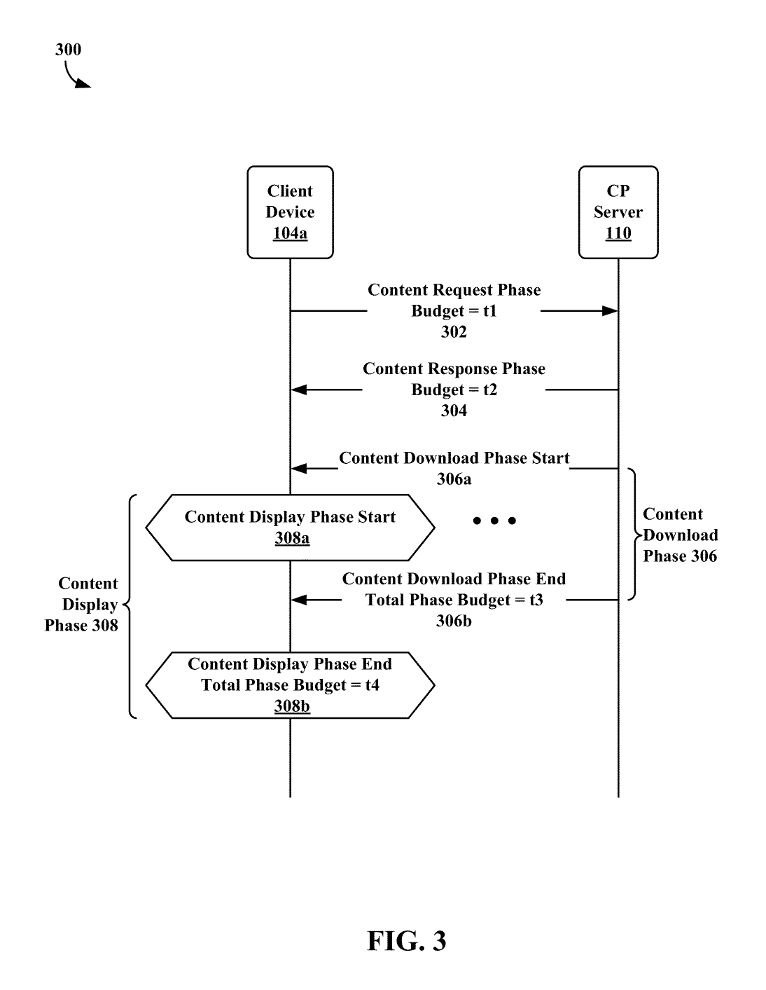

FIG. 3 is a ladder diagram 300 in accordance with an example embodiment. Ladder diagram 300 depicts an example set of phases for content delivery between client device 104a and critical-path (CP) server 110. In other scenarios not shown in FIG. 3, other client devices other than 104a could be used, while in still other scenarios, more, fewer, and/or different phases for content delivery between a client device and a critical path server could be utilized.

During content request phase 302, client device 104a can request content from critical-path server 110. Content request phase 302 can include processing of content requests according to one or more content-delivery-related protocols, such as but not limited to HyperText Transfer Protocol (HTTP), Structured Stream Transport (SST), the Speedy (SPDY) Protocol, the MUX protocol, or the SMUX protocol. FIG. 3 also indicates that a time budget of t1 can be allocated for content request phase 302.

During content response phase 304, critical-path server 110 can respond to the content request sent during content request phase 302 with a content response. As with the content request, content response phase 340 can include processing of content requests in accord with one or more content-delivery-related protocols, such as but not limited to HTTP, SST, SPDY, MUX, or SMUX. FIG. 3 indicates that a time budget of t2 is allocated for content request phase 304. In some scenarios not shown in FIG. 3, the content response of content response phase 304 can include some or all of the content requested during content request phase 302.

After responding to the content request, critical-path server 110 can begin to download (i.e., send) the requested content to client device 104a during content download phase 306. FIG. 3 shows that content download phase 306 can begin at content download phase start 306a and can end at content download phase end 306b. FIG. 3 also indicates that a time budget of t3 can be allocated for content download phase 306.

After at least some content is downloaded to client device 104a, the downloaded content can be displayed during content display phase 308. FIG. 3 shows that content display phase 308 can begin at content display phase start 308a and can end at content display phase end 308b. FIG. 3 also indicates that a time budget of t4 can be allocated for content download phase 308.

While some phases take place serially, some of the phases in the example set of phases for content delivery can take place in parallel. For example, FIG. 3 shows that content display phase 308 overlaps content download phase 306 and so these two phases can occur in parallel. During the parallel portion of content display phase 308 and content download phase 306, content can be simultaneously downloaded to client device 104a and displayed by client device 104a.

A time budget can be determined based on the time budgets for the phases for content delivery. For example, the time budget can be the sum of the time budgets for all phases for content delivery. Using the example shown in FIG. 3, the corresponding time budget can be t1+t2+t3+t4. In other scenarios, a single time budget value can be used for the entire content delivery (i.e., content delivery could have a single phase), some of the phase time budgets could be omitted from the time budget calculation, adjustments could be made for parallel phases (e.g., subtract a portion or all of the time allocated to a phase that occurs in parallel for other phases), time for delays can be added or subtracted, and/or some or all of the phase budgets can be scaled by one or more scaling factors. Many other techniques for determining a time budget for content delivery based on time-budget entries for content delivery phases are possible as well.

The time budget can be implicitly specified. For example, the time budget can be implicitly specified using “request intervals” or intervals between making content requests. Suppose an entity makes a first content request at time ReqTime1 and later makes a second content request at time ReqTime2. The request interval RI for these two content requests can be determined by the formula RI=ReqTime2−ReqTime1.

A time budget can be specified based on a minimum, an average, and/or a maximum request interval time. For example, a time budget can be specified in terms of a minimum or maximum request interval time, such as a request interval of no less than 1 second or a request interval of no more than 3500 ms. As another example, a time budget can be specified in terms of an average request interval time, perhaps including minimum and/or maximum request interval times. Such example time budgets could include an example time budget specifying a minimum, average, or maximum request interval time of 3 seconds and an example time budget specifying minimum, average, and maximum request interval times with an average request interval time of 3 seconds±1 second.

In some cases, the implicitly-specified time budget can be used to further specify time budget entries for content delivery phases. Suppose an implicit time budget of ITB=2000 milliseconds (ms)=2 seconds has been specified. Table 1 above specifies, as an example, a percentage of the time budget used by the content request phase PER_CRP of 24%. Then, the implicitly-specified time budget value for the content request phase ITB_CRP can be determined by the formula ITB_CRP=PER_CPR*ITB=24%*2000 ms=480 ms.

Further, user ratings of content can implicitly specify a time budget. For example, suppose content was requested, but not completely displayed, within a specified time budget. A user rating of the displayed content as “unacceptable” or “not completely displayed” can indicate implicitly that the specified time budget should be increased. In contrast, if few or no “not completely displayed” ratings have been received for a predetermined number of content requests from a particular user or client device, then the implication could be that the time budget is too high, and thus could be decreased. Other techniques for implicitly specifying time budgets are possible as well.

The time budget can be explicitly specified utilizing one or more time-budget entries. Each time-budget entry can specify one or more time-budget values, or amounts of time for a corresponding phase of content delivery. Table 1 below shows an example set of time-budget entries.

TABLE 1

| | Time Budget | Percentage |
|---|---|---|
| Phase | Value | of Time Budget |
| Content Request Phase | 240 ms | 24% |
| Content Response Phase | 160 ms | 16% |
| Content Download Phase | 200 ms | 20% |
| Content Display Phase | 400 ms | 40% |

Taking the sum of the example set of time-budget entries in Table 1, a time budget of 240+160+200+400=1000 ms for content delivery can be specified. In another example, a range of values can be specified for each content delivery phase (e.g., the content request phase ranges between 50 and 250 ms). In yet another example, a single time-budget value could specify a maximum duration for content delivery. Other content delivery phases and corresponding time-budget entries could be specified as well; e.g., an “above-the-fold” or visible display complete phase and corresponding time-budget value, an “interactivity allowed” phase and corresponding “time to interactivity” time-budget value. Other explicit specifications of time budgets, content-delivery phases, time-budget entries, and/or time-budget values are possible as well.

In some cases, the component could exceed a time budget by a small amount or percentage of time, such as when the small amount/percentage of time is used to provide a better quality of service. For example, suppose the rendering component had a time budget of 1000 ms and determined that content can be rendered at a highest quality within 1050 ms (5% of the original time budget). For this example, the small additional amount of time could be used to provide a higher quality rendering.

Similarly, a time budget specifying delivery at or before a given time can include a small amount or percentage of time to exceed the time budget. As an example, suppose content is budgeted to be delivered by 12:00:00 PM with a 5 second amount of permitted delay. Then, if the content were delivered at 12:00:03 PM, the content can be considered to be delivered within the time budget including the permitted delay. Many other examples of providing time-budget values to components and component use of time budget values are possible as well.

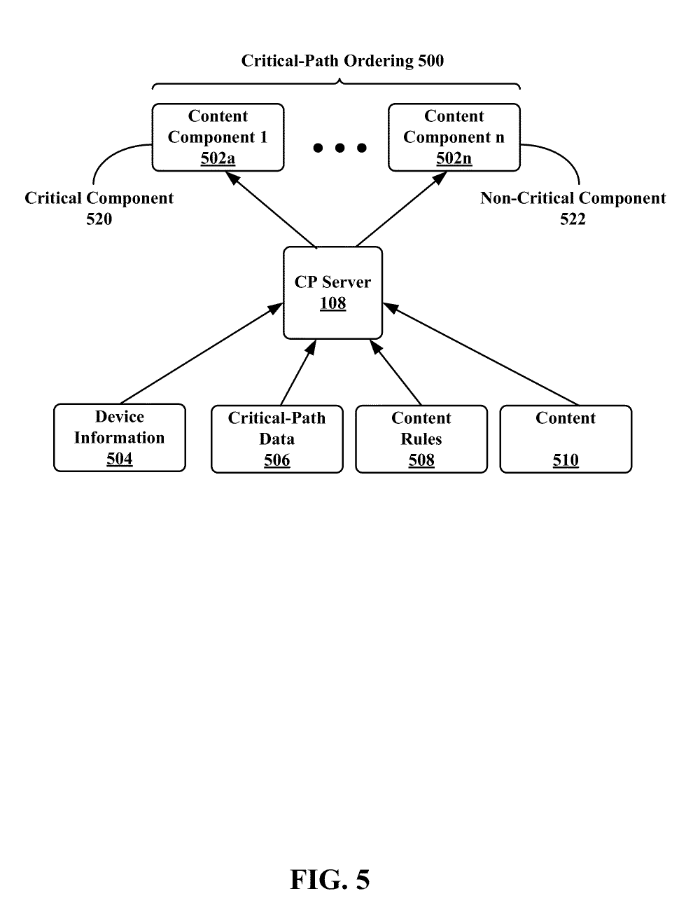

The decision to use additional amounts of time and/or the corresponding amounts of time can be specified in critical-path data, such as discussed below in the context of FIG. 5. For example, the critical-path data can include a parameter to decide whether to use or not to use additional amounts of time without specifying the amount. As another example, the critical-path data can specify amounts of additional times but leave the decision to use such additional amounts of time with the critical-path server. Many other examples of providing time-budget values to components and component use of time-budget values are possible as well.

Techniques for explicit and implicit specification of time budgets can be combined. For example, a time budget can be determined using the above-mentioned implicit-budgeting techniques and then tuned using explicit specification of time budgets for one or more phases of content delivery. As another example, explicitly-specified time budgets can be used to determine percentages of time budgets explicitly, such as via data entry, or implicitly. For example, the time-budget entries for all phases P₁ . . . Pₙ can be specified to get a time budget TBₙ, then the implicit percentage IPᵢ for phase Pᵢ (0<=i<=n) can be determined as IPᵢ=Pᵢ/TBₙ*100%. Then, the percentages of time budgets can be used, as discussed above, to specify time-budget entries based an implicit time budget. Other combinations of explicit and implicit time budgets are possible as well.

Critical-Path Ordering of Content

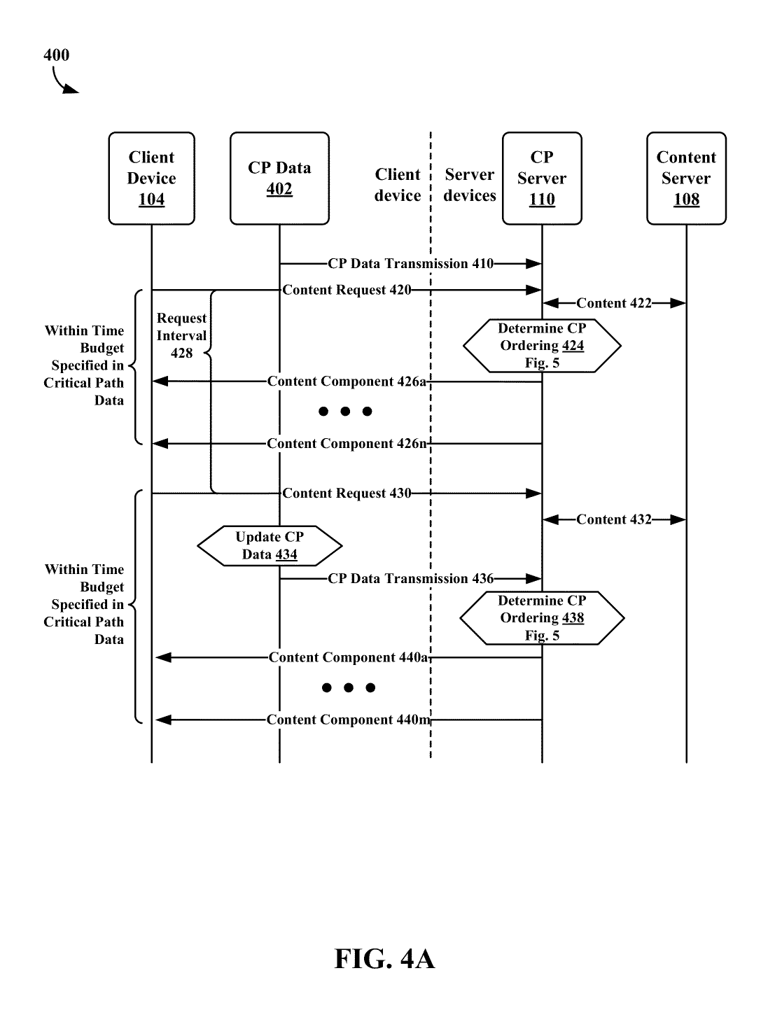

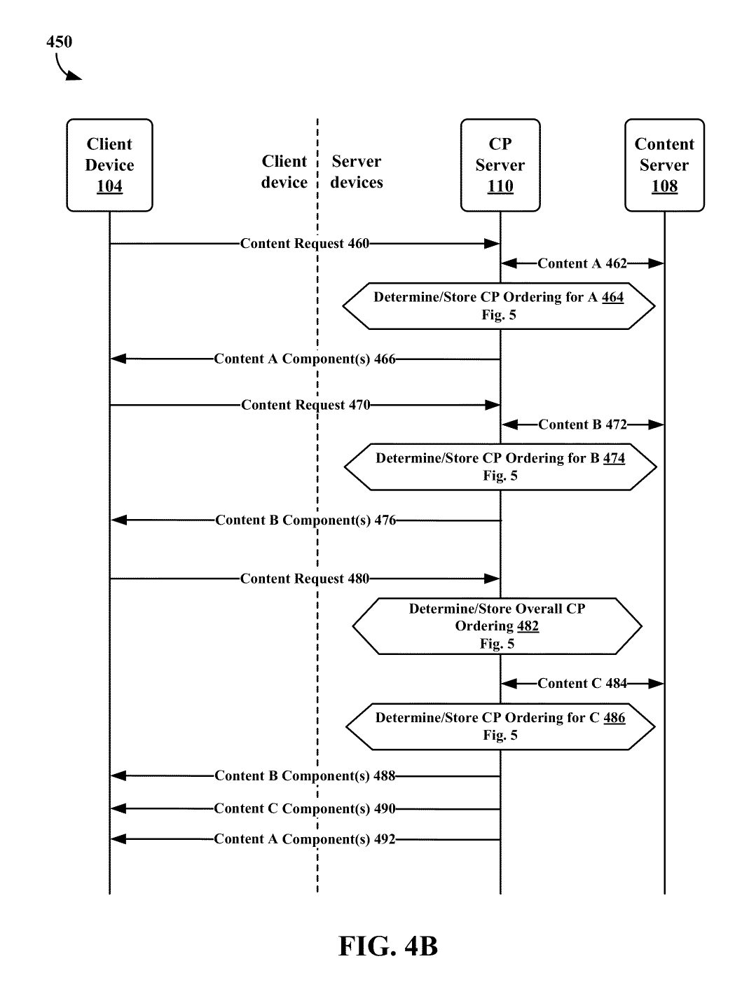

FIG. 4A is a ladder diagram 400 in accordance with an example embodiment. A transmission of critical data 402 is communicated from a client device 104 to critical-path server 110 via critical-path (CP) transmission 410. Critical-path data is described below in more detail in the context of FIG. 5.

Client device 104 can communicate content request 420 to request content delivery via critical-path server 110. Upon reception of content request 420, critical-path server 110 can request content 422 from content server 108 as specified in content request 420. Content server 108 can deliver content 422 to critical-path server 110.

At block 424, upon reception of content 422, critical-path server 110 can determine a critical-path ordering 424 for content components 426a-426n of content 422. The critical-path ordering can be determined using the techniques described below in the context of at least FIG. 5. Using the critical-path ordering, critical-path server 108 can communicate content components 426a-426n to client device 104. As shown in FIG. 4A, content components 426a-426n are delivered within a time budget specified in critical-path data 402 and communicated via critical-path data transmission 410.

After request interval of time 428, client device 104 sends another content request 430 to critical-path server 110. Upon reception of content request 430, critical-path server 110 can request content 432 from content server 108 as specified in content request 430. Content server 108 can deliver content 432 to critical-path server 110.

At block 434, client device 104 can implicitly update a time budget specified in critical-path data 402 based on request interval 428. Implicit specification of time budgets using request intervals is discussed above in more detail in the context of at least FIG. 3. Upon updating critical-path data 402, client device 104 can communicate updated critical-path data 402 to critical-path server 110 using critical-path data communication 436.

At block 438, upon reception of content 432 and updated critical-path data via critical-path data communication 436, critical-path server 110 can determine a critical path 438 for content components 440a-440m of content 432. The critical-path ordering can be determined using the techniques described below in the context of at least FIG. 5. Using the critical-path ordering, critical-path server 108 can communicate content components 440a-440m to client device 104. As shown in FIG. 4A, content components 440a-440m are delivered within a time budget specified in critical-path data 402 and communicated via critical-path data transmissions 410 and 436.

FIG. 4B is a ladder diagram 450 illustrating an overall critical-path ordering in accordance with an example embodiment. In the example scenario illustrated using ladder diagram 450, client device 104 can communicate a first content request 460 to request content delivery via critical-path server 110. Upon reception of first content request 460, critical-path server 110 can request content A 462 from content server 108 as specified in first content request 460. Content server 108 can deliver content A 462 to critical-path server 110.

At block 464, upon reception of content A 462, critical-path server 110 can determine a critical-path ordering for content components of content A 462. The critical-path ordering for content A can be determined using the techniques described below in the context of at least FIG. 5.

Also at block 464, the critical-path ordering for content A can be stored, perhaps in an index, cache, or other memory of critical path server 110. Using the critical-path ordering, critical-path server 108 can communicate content component(s) 466 of content A 462 to client device 104. Critical-path orderings can be stored in an index with associated search terms to permit later querying and retrieval of generated critical-path orderings. The storage of critical-path orderings, in a cache, memory, and/or in an index, can be managed using one or more memory storage algorithms, such as, but not limited to, a first-in-first-out (FIFO) algorithm, a last-in-first-out (LIFO) algorithm, a least recently used (LRU) algorithm, or a most recently used (MRU) algorithm.

Client device 104 can send second content request 470 to critical-path server 110. Upon reception of second content request 470, critical-path server 110 can request content B 472 from content server 108 as specified in second content request 470. Content server 108 can deliver content B 472 to critical-path server 110.

At block 474, upon reception of content B 472, critical-path server 110 can determine a critical-path ordering for content components of content B 472. The critical-path ordering for content B can be determined using the techniques described below in the context of at least FIG. 5.

Also at block 474, the critical-path ordering for content B can be stored, perhaps in a cache or other memory of critical path server 110. Using the critical-path ordering, critical-path server 108 can communicate content component(s) 476 of content B 472 to client device 104.

Client device 104 can send third content request 480 to critical-path server 110. In the example scenario illustrated using ladder diagram 450, third content request 480 is related to three content items: content A, content B, and a third content item, content C. For example, third content request 480 can be a request for recent, historical, local, regional, national, and/or international information on one or more topics, such as, but not limited to, news, sports, fashion, finance, technology, legal, health/medicine, safety, weather, and/or advice.

At block 482, an overall critical-path ordering responsive to third content request 480 is determined and perhaps stored. The overall critical-path ordering can arrange the related content items based on one or more content-item criteria, such as, but not limited to, device information, critical-path data, content rules, the content of the content-item, time information, and/or location information.

Critical-path server 110 can search for stored critical-path orderings for the one or more content items related to the overall critical-path ordering. In the example scenario illustrated using ladder diagram 450, the overall critical-path ordering orders three content items—content A, content B, and content C—for delivery in the order of: content B, content C, and content A. In this example scenario, critical-path server finds stored critical-path orderings for content A (stored at block 464) and content B (stored at block 474), but does not find a critical-path ordering for content C. In order to generate a critical-path ordering of content C, critical-path server can request delivery of content C 484 from content server 108.

In some scenarios, such as shown in FIG. 4B, critical-path server 110 does not need additional content to generate a critical-path ordering. For example, critical-path server 110 can store an index storing information about content items related to an overall critical-path ordering. Taking the example of the World News content request, the index can store entries with information about news items; e.g., titles and/or abstracts, along with links to additional information, such as the underlying news items. As another example, an index for science-fiction novels can store entries with information about books; e.g., titles, authors, and abstracts for all science fiction novels in print, along with links to additional information, such as pictures of authors and/or book covers, book reviews, links to websites to purchase science fiction novels, etc.

In some scenarios, critical-path server 108 does not require additional information beyond information stored in one or more indices to generate an overall critical-path ordering. Instead, critical-path server 108 can search the one or more indices, perhaps stored on critical-path server 108, to retrieve index entries related to the content request. Critical path server 108 can generate the overall critical-path ordering based on the retrieved index entries. Then, critical-path server can generate content-specific critical-path orderings based on content retrieved, perhaps from content server 110, using the links to additional information.

In some situations, the content-specific critical-path orderings and/or the overall critical-path orderings can be stored and perhaps reused. In particular of these situations, critical-path orderings can in turn be stored in an index with suitable terms for searching critical-path orderings, such as part or all of a content request, part or all of the critical-path data, timing information, addressing information, and/or other information. Other examples are possible as well.

At block 486, upon reception of content C 484, critical-path server 110 can determine a critical-path ordering for content components of content C 484. The critical-path ordering for content C can be determined using the techniques described below in the context of at least FIG. 5. Also at block 484, the critical-path ordering for content C 484 can be stored, perhaps in an index, cache, or other memory of critical path server 110.

Critical-path server 110 can deliver components of content in accord with the overall critical-path ordering and critical-path ordering(s) of content item(s) related to the overall critical-path ordering. FIG. 4B depicts critical-path server 110, in response to third content request 480, delivering content B components 488 first, content C components 490 second, and content A components 492 third, in accord with the overall critical-path ordering generated at block 482. Delivery of the content B components can be in accord with the critical-path ordering of content B generated/stored at block 474. Similarly, delivery of the content C components and content A components can be in accord with the critical-path orderings generated/stored at block 482 and block 464, respectively.

FIG. 5 depicts a critical-path ordering 500 of content 510 in accordance with an example embodiment. To generate critical-path ordering 500 for content components 502a-502n of content 510, critical-path server 108 can use device information 504, critical-path data 506, content rules 508, and content 510.

Device information 504 can include information related to a client device configured to display content 510, including but not limited to display information, audio information, and/or connection information. Display information can include information about one or more displays of the client device, including but not limited to display capabilities (e.g., not present, monochrome, color), display-size information (e.g., display height, display width), and/or supported display format and/or version information (e.g., HTML 5, Flash, PDF, etc.). Audio information can include information about one or more audio outputs of the client device, including but not limited to (e.g., not present, monaural, stereo) and/or support audio format and/or version information (e.g., MPEG 3 audio, WAV, au, etc.). Connection information can include information about one or more connections to the client device, including but not limited to bandwidth information, round-trip delay information, upload speeds, download speeds, and/or maximum number of connections. Other device information can be included as well.

Critical-path data 506 can include one or more preferences specified by an entity using a client device. The one or more preferences can include one or more time-budget entries and/or preferences for exceeding a time budget by one or more phases by a predetermined amount or percentage to permit higher quality service as discussed above in the context of FIG. 3. Critical-path data 506 can specify whether or not time-budget entries can be exceeded and by what amount to allow display of the content (e.g., 5%, 10 ms).

Other preferences in critical-path data 506 can include content-priority preferences. For example, the entity may prefer to have text of a web page (or other content) delivered before images in the web page are delivered. In this example, a content-priority preference can indicate that text has a higher priority than images. Content-priority preferences can involve selection of sub-types of content. For example, text can be sub-divided into time-sensitive text and non-time-sensitive text. If desired, time-sensitive text can be prioritized over non-time-sensitive text (or vice versa).

Keywords or other content can be used to specify content-priority preferences. For example an investor in ABCDE Corporation could specify that text that includes a keyword of “ABCDE” is to be prioritized over other text.

Content-priority preferences can be combined. For example, a fan of the TV show “Runaway Project” could specify that that text including the keyword “Runaway Project” has a higher priority over other text with requested content but has a lower priority than any images in the requested content.

Content-priority preferences can involve prioritization of one or more sources of content. For example, content from sources in the “ghos.com” domain can have a higher priority than content from sources in the “cs.superstudy.edu” sub-domain. Many other types of critical-path data, including but not limited to other types of time-budget entries and/or content-priority preferences, are possible as well.

Content-priority preferences and/or time-budget entries can be used to permit an entity to make tradeoffs between various aspects of content delivery. For example, by specifying a relatively-short time budget, an entity can prioritize content delivery speed over content delivery quality. By specifying delivery of various content-priority preferences, the entity can specify which types of content are delivered first. Other tradeoffs are possible as well.

Content rules 508 can be applied to content 510 to determine one or more components 502a-502n of content 510. Each component 502a-502n can include a component type such as, but not limited to, text, audio, video, image, binary data, compressed data, and/or encrypted data. For examples, content rules 508 can specify that some or all text of content 510 is classified as a text component of content 510 and that one or more images in content 510 are classified as image component(s) of content 510. Many other content rules and/or component types are possible as well.

In some cases, content server 108 can prioritize components of content, such as content 422 or content 432, to deliver the content to critical-path server 110. For example, content server 108 can prioritize textual data over image data or vice versa. Critical-path server 110 can use the priorities set by content server 108 to determine critical-path ordering 500. For example, content rules 508 can use priority information provided by content server 108, perhaps provided as priority information of one or more network streams used to provide content to critical-path server 110. As another example, implicit priorities of components based on delivery times can be determined and used in determining critical-path ordering 500; e.g., the first received component has the highest-priority, the second received component has the second-highest priority, etc.

Then, critical-path ordering 500 can be determined by applying device information 504 and/or critical-path data 506 to components 502a-502n. For example, if component 502a would not be displayed in a client device used to display content 510 but component 502n would be displayed, then critical-path ordering 500 can indicate that component 502n is to be communicated before component 502a. As another example, if device information 504 indicates that the client device does not have an audio output present, then critical-path ordering 500 can specify that audio components of content 510 are to be delivered after other types of components.

Critical-path ordering 500 can be based on one or more network conditions as well. For example, the implicit priorities of components discussed just above account for network conditions by prioritizing components based on delivery time via a network. The critical-path server 108 can otherwise obtain information about network conditions. For example, critical-path server 108 can examine data based on network conditions, such as round-trip delay times and/or routing tables. As another example, critical-path server 108 can send test messages such as “ping” messages to observe round-trip delay times. Critical-path server 108 also can use other techniques for obtaining network-condition information.

Network-condition information can affect content delivery as well; for example, relatively low-quality image, audio, or video data can be sent over a relatively slow network (as determined based on the network-condition information) while a relatively high-quality image, audio, or video data can be sent over a relatively-fast networks. Other techniques for obtaining network-condition information, determining network-condition information, and content delivery based on network-condition information are possible as well.

Applying critical data 506, such as time budgets and/or content-priority preferences, can also be used to determine critical-path ordering 500 as discussed immediately above. As a further example, connection information in device information 504 along with size information for components 502a-502n can be used to determine an estimated time to communicate each of component 502a-502n. For example, suppose content 510 includes three components with respective sizes of 200 kilobits, 400 kilobits, and 80 kilobits. In this example, suppose that connection information indicates that only one connection of with a maximum download speed of 800 kilobits/second is available to a client device. Then, the respective estimated times to communicate the three example components are 0.25 seconds, 0.5 seconds, and 0.1 seconds.

If a component of content 510 of a predetermined size cannot be delivered within a time budget specified by critical data 506, critical-path ordering 500 can indicate that the undeliverable component is have a lower priority than other components of content 510. Continuing the three-component example of the above paragraph, suppose the time budget for delivery of content 510 is specified in critical data as 0.4 seconds. Based on the time budget and the estimated time to communicate the three example components, the 400 kilobit component cannot be communicated during the time budget. Thus, critical-path ordering 500 can indicate that the 400 kilobit component has a lower priority than the 200 kilobit and 50 kilobit components.

Once critical-path ordering 500 of components 502a-502n is determined, content 510 can be delivered to a client device on a component-by-component basis in accordance with critical-path ordering 500. In some cases, the highest-priority (and perhaps other relatively high-priority) components of critical-path ordering 500 can be considered as critical components, while the lowest-priority (and perhaps other relatively low-priority) of critical-path ordering 500 components can be considered to be non-critical components. FIG. 5 shows highest-priority component 502a labeled as critical component 520 and shows lowest-priority component 502n labeled as non-critical component 522.

In some embodiments, critical-path server 110 can transmit components 502a-502n directly to a requesting entity, such as a client device. In other embodiments, critical-path server can transmit critical-path ordering 500 to another server, such as content server 108, which in turn can deliver components 502a-502n to the requesting entity in accord with critical-path ordering 500.

In still other embodiments, critical-path server 110 can transmit components 502a-502n in accord with critical-path ordering 500 to a particular server. The particular server can store components 502a-502n and deliver them to in accord with critical-path ordering 500 to one or more requesting entities. For example, suppose the particular server were to determine that a group G of requesting entities used the same type of device and had similar (or the same) critical-path data. Then, the particular server could request critical-path server 110 to transmit components 502a-502n of content 510 in accord with critical-path ordering 500 and store components 502a-502n as delivered. When a requesting entity in group G requests content 510 from the particular server, the particular server could transmit components 502a-502n, stored in accord with critical-path ordering 500, to the requesting entity that is a member of group G.

Delivery of some components of content 510 can involve multiple delivery operations. For example, delivery of image components can include communicating one or more interlaced or progressive images. As another example, time-sensitive text (or other time-sensitive data such as streaming media components) can change during content delivery and thus could be retransmitted to provide the most current version of the time-sensitive data. Other scenarios requiring multiple delivery operations for one or more components of content 510 are possible as well.

Example Communications

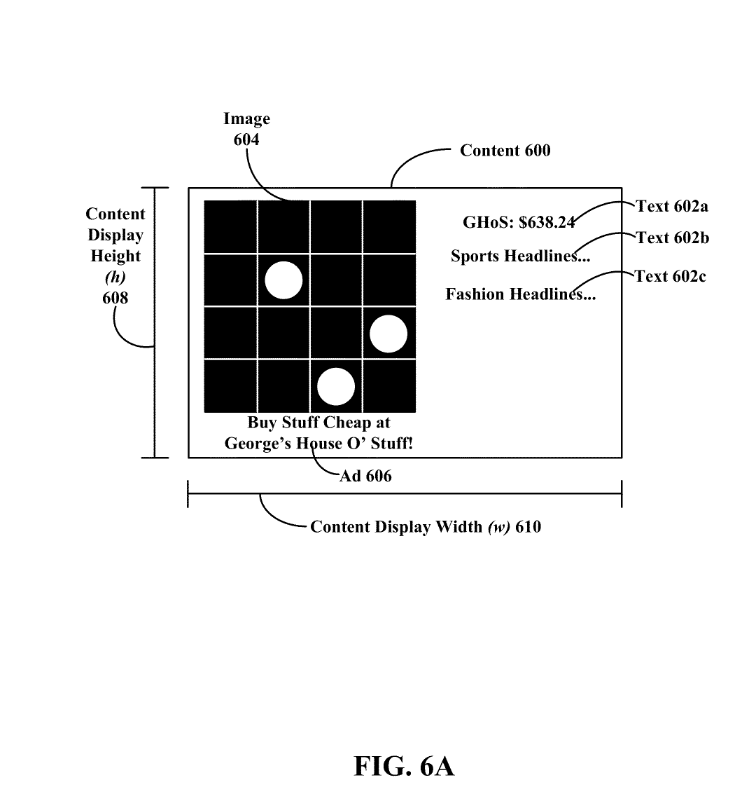

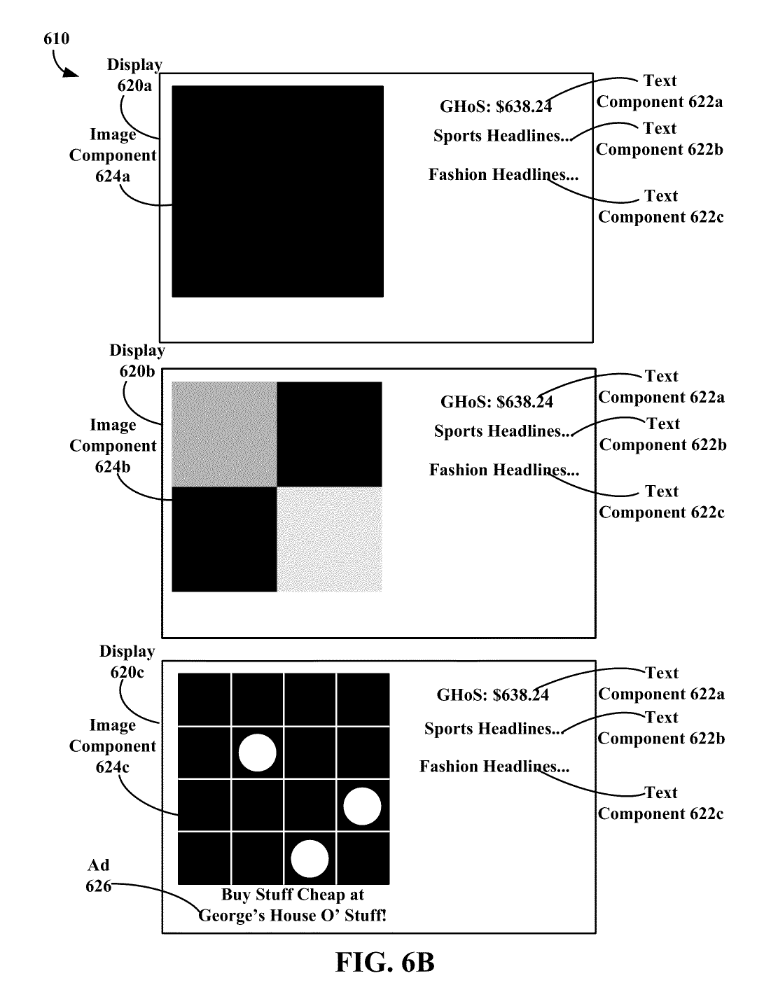

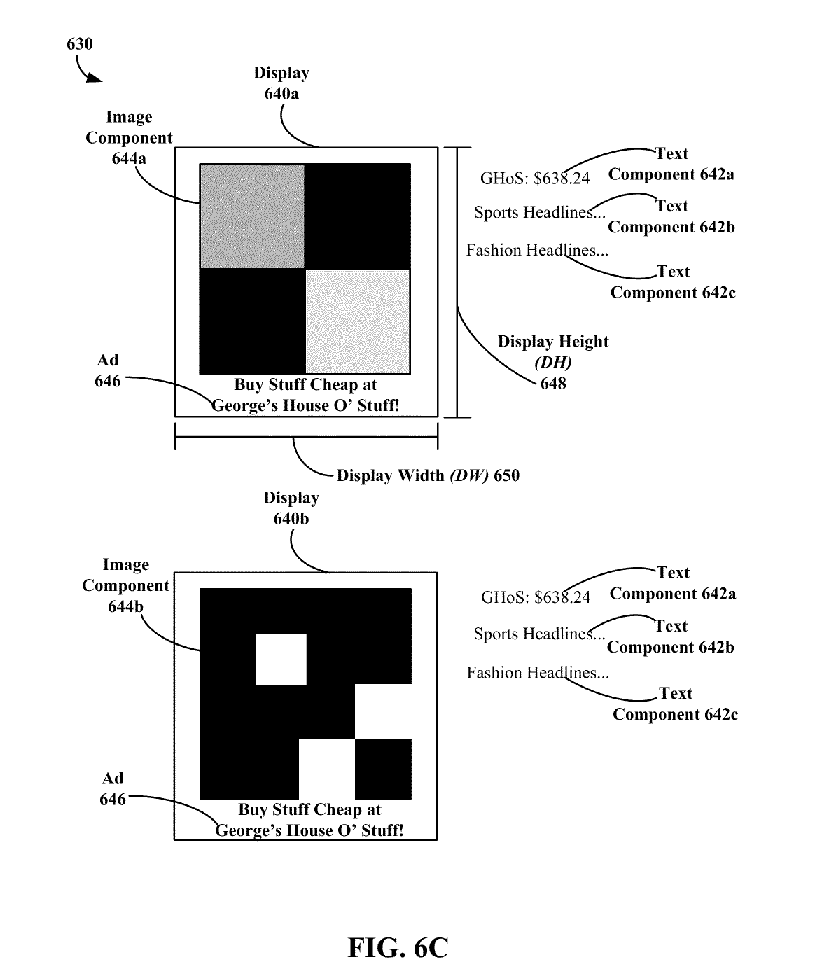

FIG. 6A illustrates example content 600 in accordance with an example embodiment. Example content 600 includes text 602a, 602b, and 602c, image 604, and advertisement (ad) 606. FIG. 6A shows that content 600 has content display height 608 of h and a content display width 610 of w.

Content 600 can be available from one or more content sources, such as content server 108. For example, ad 606 can be delivered from a different content source than text 602a-602c and/or image 604. Upon delivery, ad 606 can be aggregated with text 602a-602c and image 604 to form a display of content 600.

Based on an analysis of content 600 applying content rules 508, critical-path server 110 can determine that content 600 has five components: text components corresponding to text 602a, 602b, 602c and ad 606, an image component corresponding to image 604. Critical-path server 110 can apply additional content rules 508 on text components 602a, 602b, and 602c to determine that text component 602a includes time-sensitive data, text components 602b and 602c include non-time-sensitive data (text for links to additional sports and fashion information, respectively), and that ad 606 is an ad component. In some situations not shown in FIGS. 6A-6C, critical-path server 110 can treat ad 606 as a text component of content 600.

Many other examples of content available from one or more content sources are possible as well. These other examples of content may have more, fewer, or the same number of components, components may have same and/or different types, and/or may have different or the same content display heights and/or widths as content 600.

FIG. 6B shows a scenario 610 for displaying content 600 in accordance with an example embodiment. In particular, scenario 610 begins after a content request has been made for content 600, and part of content 600 has been delivered to a client device (e.g., client device 104a, 104b, or 104c) for display. As such, scenario 610 can occur during content download phase 306 and content display phase 308 for displaying content 600.

In scenario 610, critical-path data 506 can include an indication that text components should have a higher priority than image components or ad components and an indication that time-sensitive text components should have a higher priority than non-time-sensitive text components. A critical-path ordering for scenario 610 can involve critical-path server 110 applying the indications in critical-path data 506 to the five components of display 600. Then, critical-path server 110 can determine a critical-path ordering of the five components of content 600 with text 602a having a highest priority, text 602b and 602c having a next-highest priority, and image 604 and ad 606 having lower priorities than text 602b and 602c.

FIG. 6B shows display 620a with three text components 622a-622c and image component 624a for content 600. Text components 622a-622c include the time-sensitive text component 622a corresponding to text 602a of content 600, and the two non-time-sensitive text components 622b and 622 respectively corresponding to text 602b and 602c of content 600. Image component 624a can be a “coarse” version of image 604 of content 600. A coarse version of an image component can have some, but not all features of image 604. As shown in FIG. 6B, image component 624a only includes a background color of image 604.

Display 620a does not include a display corresponding to ad 606. That is, display 620a shows a partial display of the components of content 600. As discussed above, this partial display 620a of content 600 is in accordance with the critical-path data 506 and corresponding critical-path ordering of content 600 for scenario 610.

FIG. 6B shows display 620b at a later point during the content download phase 306 and content display phase 308. In particular, display 620b shows three text components 622a, 622b, and 622c, and a coarse version of image 604 as image component 624b. While both image components 624a and 624b are coarse versions of image 604, image component 624b is shown with more of the information content of image 604. For example, image component 624b can use interlaced or progressive display techniques to communicate and display of image 604. As discussed above, display 620b is in accordance with the critical-path data 502 and corresponding critical-path ordering 500 of content 600 for scenario 610.

FIG. 6B shows display 620c after content download and content display phases for delivering content 600 have completed. Display 620c shows complete versions of the five components of content 600 as text components 622a-622c, image component 624c, and ad 626. In particular, image component 624c is a complete (i.e., not coarse) version of image 604.

FIG. 6C shows another scenario 630 for displaying content 600 in accordance with an example embodiment. In scenario 630, a time budget TB has been specified. Scenario 630 uses a device with a display height 648 of DH and a display width 650 of DW for displaying content 600. FIG. 6C shows that DH is equal to h (the content display height 608 for content 600), but DW is less than content display width 610 of w (the content display width 610 for content 600).

In scenario 630, device information 504 can include display height DH and display width DW to indicate a size of displaying content 600. Also for scenario 630, critical-path data 506 can include one or more time-budget entries specifying time budget TB. A critical-path ordering for scenario 630 can involve critical-path server 110 applying device information 504 and critical-path data 506 to the five components of display 600.

Critical-path server 110 can determine a critical-path ordering of the five components of content 600 with image 604 and ad 606 as having a higher priority as being visible components having a highest priority and with text components 642a-642c having correspondingly lower priorities. In scenario 630, ad 606 can have a smaller size than image 640. Then, determining a critical-path ordering in scenario 630 can involve using size and connection information to estimate that ad 606 is likely to take less time to display than image 604. In this example, the critical-path ordering can prioritize ad 606 over image 604.

As with scenario 610, scenario 630 begins after a content request has been made for content 600, and part of content 600 has been delivered to a client device (e.g., client device 104a, 104b, or 104c) for display. As such, scenario 630 can occur during content download phase 306 and content display phase 308 for displaying content 600.

FIG. 6C shows display 640a with ad 646 is bold text to indicate that ad 646 has been displayed. In contrast, three text components 642a-642c are shown in FIG. 6C in non-bolded text to indicate they are not displayed (and thus not visible) in display 640a.

FIG. 6C also shows image component 644a for content 600 as a coarse version of image 604. Critical-path server 110 can, in accordance with a critical-path ordering, defer communication of non-displayable text components 642a-642c until all visible components including image component 644a are communicated. That is, text components 642a-642c may not be communicated until a complete version of image component 644a is communicated and/or displayed.

FIG. 6C shows display 640b with ad 646 displayed and text components 642a-642c not displayed. Image component 644b is a further-refined but still coarse version of image 604. In scenario 630, the specified time-budget TB expired after rendering display 640; that is, an incomplete version of content 600 was communicated and displayed by a client device rendering displays 640a and 640b. Upon reviewing the incomplete version of content 600, display 640b can be rated as “not completely displayed”, perhaps to implicitly increase time budget TB.

Example Operation

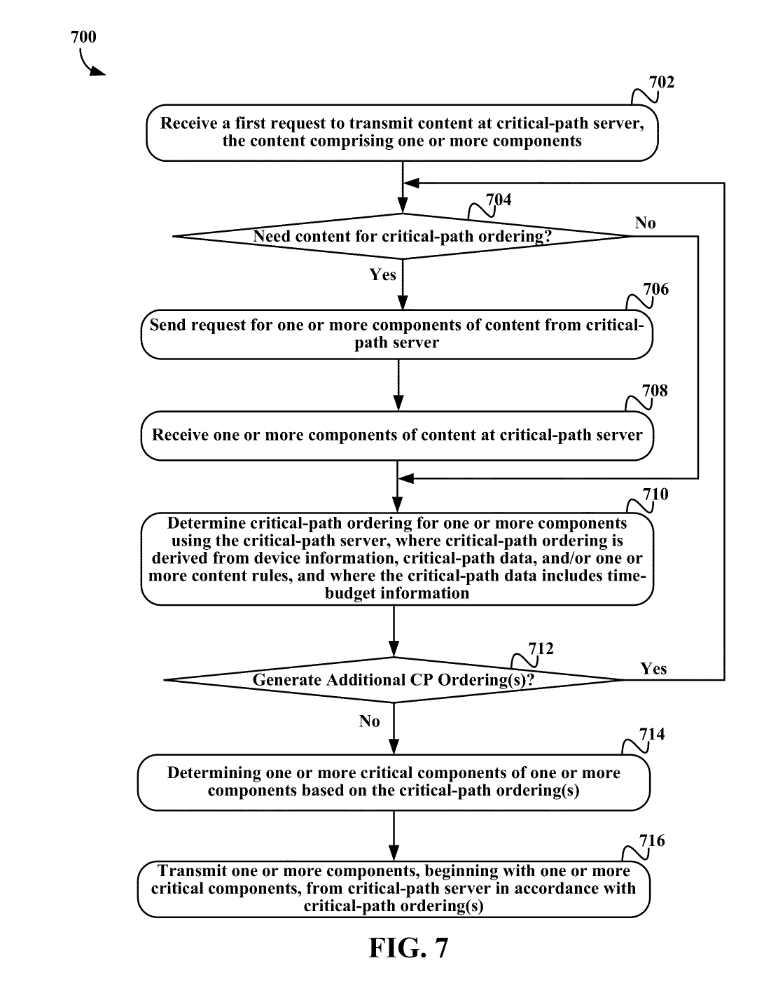

FIG. 7 is a flow chart of another example method 700 in accordance with an example embodiment. At block 702, a first request to transmit content can be received at a critical-path server. The content can include one or more components. In some embodiments, the one or more components include at least one critical component, while in particular embodiments, the one or more components include two or more critical components. In other embodiments, the one or more components include at least one non-critical component. In some of these other embodiments, the one or more components include one or more critical components and at least one non-critical component. Receiving requests to transmit components of content is described above in the context of at least FIGS. 4A, 4B, 5, 6B, and 6C.

At block 704, a determination can be made as to whether or not additional content is required to generate a critical-path ordering. For example, the critical-path server could determine that the required critical-path ordering is an overall critical-path ordering and that the critical-path server already stores any necessary information regarding content item(s) that could be part of the critical-path ordering, such as an index discussed in more detail above in the context of FIG. 4B. As another example, the critical-path server can retrieve the one or more components from a memory; for example, the one or more components can have been previously received and then stored by the critical-path server. In other examples, the critical-path server requires content deliver prior to generating the critical-path ordering, such as discussed above in the context of FIGS. 4A, 4B, 5, 6A, 6B, and 6C.

If content is not required to generate the critical-path ordering, method 700 can proceed to block 710. Otherwise, if content is required to generate the critical-path ordering, method 700 can proceed to block 706.

At block 706, the critical-path server can send a request for the one or more components of content. Requesting components of content is described above in the context of at least FIGS. 4A, 4B, 5, 6B, and 6C.

At block 708, one or more components of the content can be received at the critical-path server. Receiving components of content is described above in the context of at least FIGS. 4A, 4B, 5, 6B, and 6C.

At block 710, a critical-path ordering for the one or more components can be determined using the critical-path server. The critical-path ordering can be based on device information, critical-path data, and/or one or more content rules. The critical-path data can include time-budget information.

In some cases, the critical-path data can be related to one or more preferences, such as but not limited to time-budget entries and content-priority preferences. In other cases, the critical-path ordering can be determined based on one or more network conditions. Critical-path orderings are described above in the context of at least FIGS. 4A, 4B, 5, 6B, and 6C.

At block 712, a determination is made as to whether or not additional critical-path orderings are needed to satisfy the first request to transmit content. If additional critical-path orderings are needed, method 700 can proceed to block 704. Otherwise, if no additional critical-path orderings are needed, method 700 can proceed to block 714.

At block 714, one or more critical components of the one or more components are determined based on the critical-path ordering(s). Determining critical components based on critical-path orderings is described above in the context of at least FIG. 5.

At block 716, the one or more components can be transmitted from the critical path server in accordance with the critical-path ordering(s). The one or more components can begin with the one or more critical components. Transmission of components of content in accordance with critical-path orderings are described above in the context of at least FIGS. 4A, 4B, 5, 6B, and 6C.

In some embodiments, the critical-path server can transmit the critical-path ordering(s). Transmitting critical-path orderings is described above in the context of at least FIG. 5.

### CONCLUSION

With respect to any or all of the ladder diagrams, scenarios, and flow charts in the figures and as discussed herein, each block and/or communication may represent a processing of information and/or a transmission of information in accordance with example embodiments. Alternative embodiments are included within the scope of these example embodiments. In these alternative embodiments, for example, functions described as blocks, transmissions, communications, requests, responses, and/or messages may be executed out of order from that shown or discussed, including substantially concurrent or in reverse order, depending on the functionality involved. Further, more or fewer blocks and/or functions may be used with any of the ladder diagrams, scenarios, and flow charts discussed herein, and these ladder diagrams, scenarios, and flow charts may be combined with one another, in part or in whole.

A block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical functions or actions in the method or technique. The program code and/or related data may be stored on any type of computer readable medium such as a storage device including a disk or hard drive or other storage medium.

The computer readable medium may also include non-transitory computer readable media such as computer-readable media that stores data for short periods of time like register memory, processor cache, and random access memory (RAM). The computer readable media may also include non-transitory computer readable media that stores program code and/or data for longer periods of time, such as secondary or persistent long term storage, like read only memory (ROM), optical or magnetic disks, compact-disc read only memory (CD-ROM), for example. The computer readable media may also be any other volatile or non-volatile storage systems. A computer readable medium may be considered a computer readable storage medium, for example, or a tangible storage device.

Moreover, a block that represents one or more information transmissions may correspond to information transmissions between software and/or hardware modules in the same physical device. However, other information transmissions may be between software modules and/or hardware modules in different physical devices.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method, comprising:
receiving a first request to transmit content at a critical-path server, the content comprising one or more components;
sending a request for the one or more components of the content from the critical-path server;
receiving the one or more components of the content at the critical-path server;
determining a critical-path ordering for the one or more components of the content using the critical-path server, wherein the critical-path ordering is derived from device information, critical-path data, and one or more content rules, and wherein the critical-path data comprises time-budget information;
determining one or more critical components of the one or more components based on the critical-path ordering; and
transmitting the one or more components, beginning with the one or more critical components, from the critical-path server in accordance with the critical-path ordering.

2. The method of claim 1, further comprising transmitting the critical-path ordering from the critical-path server.

3. The method of claim 1, wherein the one or more components comprise the one or more critical components and at least one non-critical component.

4. The method of claim 1, further comprising:
receiving a second request to transmit content at the critical-path server;
determining a request interval between the first request to transmit content and the second request to transmit content; and
updating the time-budget information based on the request interval.

5. The method of claim 1, further comprising:
receiving a rating of a display of the content; and
updating the time-budget information based on the received rating.

6. The method of claim 1, wherein the time-budget information comprises time-budget information for each of one or more phases of content delivery.

7. The method of claim 6, further comprising: determining a time budget for delivering the content based on the time-budget information for the one or more phases of content delivery.

8. The method of claim 1, wherein the device information includes information about one or more processors of a device configured to generate a display of the content.

9. The method of claim 1, wherein the critical-path ordering is further based on connection information about one or more networks connected to the critical-path server.

10. The method of claim 1, wherein determining the critical-path ordering comprises:
determining the one or more components of the content by applying the one or more content rules to the content;
determining a component type for each of the one or more components of the content based on the content rules;
determining a component priority for each of the one or more components of the content based at least in part on the respective component types; and
determining the critical-path ordering for the one or more components of the content based on the respective component priorities.

11. A method, comprising:
receiving a request to transmit content at a critical-path server, the content comprising one or more components;
determining whether or not additional content is required to generate a first critical-path ordering;
responsive to determining that additional content is not required to generate the first critical-path ordering, generating the first critical-path ordering using the critical-path server, wherein the first critical-path ordering is derived at least from device information and critical-path data, and wherein the critical-path data comprises time-budget information;
determining one or more critical components of the one or more components based on the first critical-path ordering; and
transmitting the one or more components, beginning with the one or more critical components, from the critical-path server in accordance with the first critical-path ordering.

12. The method of claim 11, further comprising:
responsive to determining that additional content is required to generate the first critical-path ordering:
(a) sending a request for the one or more components of the content from the critical-path server,
(b) receiving the one or more components of the content at the critical-path server, and
(c) generating the first critical-path ordering for the one or more components using the critical-path server, wherein the first critical-path ordering is derived from the device information, the critical-path data, and one or more content rules.

13. A system, comprising:
one or more processors configured to:
receive a first request to transmit content, the content comprising one or more components;
sending a request for the one or more components;
receive the one or more components of the content;
determine a critical-path ordering for the one or more components of the content, wherein the critical-path ordering is derived from device information, critical-path data, and one or more content rules, and wherein the critical-path data comprises time-budget information;
determine one or more critical components of the one or more components based on the critical-path ordering; and
transmit the one or more components, beginning with the one or more critical components, in accordance with the critical-path ordering.

14. The system of claim 13, wherein the system is further configured to transmit the critical-path ordering.

15. The system of claim 13, wherein the one or more components comprise the one or more critical components and at least one non-critical component.

16. The system of claim 13, wherein the one or more processors are further configured to:
receive a second request to transmit content at the critical-path server;
determine a request interval between the first request to transmit content and the second request to transmit content; and
update the time-budget information based on the request interval.

17. The system of claim 13, wherein the one or more processors are further configured to:
receive a rating of a display of the content; and
update the time-budget information based on the received rating.

18. The system of claim 13, wherein the time-budget information comprises time-budget information for each of one or more phases of content delivery.

19. The system of claim 18, wherein the one or more processors are further configured to: determine a time budget for delivering the content based on the time-budget information for the one or more phases of content delivery.

20. The system of claim 13, wherein the device information includes information about one or more processors of a device configured to generate a display of the content.

21. The system of claim 13, wherein the critical-path ordering is further based on connection information about one or more networks.

22. The system of claim 13, wherein the one or more processors configured to determine the critical-path ordering are configured at least to:
determine the one or more components of the content by applying the one or more content rules to the content;
determine a component type for each of the one or more components of the content based on the content rules;
determine a component priority for each of the one or more components of the content based at least in part on the respective component types; and
determine the critical-path ordering for the one or more components of the content based on the respective component priorities.

23. An article of manufacture including a tangible non-transitory computer-readable storage medium having computer-readable instructions encoded thereon, the computer-readable instructions comprising:
instructions for receiving a first request to transmit content, the content comprising one or more components;
instructions for sending a request for the one or more components;
instructions for receiving the one or more components of the content;
instructions for determining a critical-path ordering for the one or more components of the content, wherein the critical-path ordering is derived from device information, critical-path data, and one or more content rules, and wherein the critical-path data comprises time-budget information;
instructions for determining one or more critical components of the one or more components based on the critical-path ordering; and
instructions for transmitting the one or more components, beginning with the one or more critical components, in accordance with the critical-path ordering.

24. The article of manufacture of claim 23, further comprising: instructions for transmitting the critical-path ordering.

25. The article of manufacture of claim 23, wherein the one or more components comprise the one or more critical components and at least one non-critical component.

26. The article of manufacture of claim 23, further comprising:
instructions for receiving a second request to transmit content at the critical-path server;
instructions for determining a request interval between the first request to transmit content and the second request to transmit content; and
instructions for updating the time-budget information based on the request interval.

27. The article of manufacture of claim 23, further comprising:
instructions for receiving a rating of a display of the content; and
instructions for updating the time-budget information based on the received rating.

28. The article of manufacture of claim 23, wherein the time-budget information comprises time-budget information for each of one or more phases of content delivery.

29. The article of manufacture of claim 28, further comprising: instructions for determining a time budget for delivering the content based on the time-budget information for the one or more phases of content delivery.

30. The article of manufacture of claim 23, wherein the device information includes information about one or more processors of a device configured to generate a display of the content.

31. The article of manufacture of claim 23, wherein the critical-path ordering is further based on connection information about one or more networks.

32. The article of manufacture of claim 23, wherein the instructions for determining the critical-path ordering comprise:
instructions for determining the one or more components of the content by applying the one or more content rules to the content;
instructions for determining a component type for each of the one or more components of the content based on the content rules;
instructions for determining a component priority for each of the one or more components of the content based at least in part on the respective component types; and
instructions for determining the critical-path ordering for the one or more components of the content based on the respective component priorities.

33. An apparatus, comprising:
means for receiving a first request to transmit content, the content comprising one or more components;
means for sending a request for the one or more components of the content;
means for receiving the one or more components of the content;
means for determining a critical-path ordering for the one or more components of the content, wherein the critical-path ordering is derived from device information, critical-path data, and one or more content rules, and wherein the critical-path data comprises time-budget information;
means for determining one or more critical components of the one or more components based on the critical-path ordering; and
means for transmitting the one or more components, beginning with the one or more critical components, in accordance with the critical-path ordering.
